(19) United States
(12) Patent Application Publication
(10) Pub. No.: US 2025/0326193 A1
(43) Pub. Date: Oct. 23, 2025

(54) TIRE BUILDING MACHINE FOR PRODUCING TIRE COMPONENTS AND METHOD FOR PROVIDING HUMAN ACCESS TO SAID TIRE BUILDING MACHINE

(71) Applicant: VMI HOLLAND B.V., Epe (NL)

(72) Inventors: Willem Marinus VAN BEEK, Epe (NL); Timen Anton VAN WERVEN, Epe (NL)

(21) Appl. No.: 18/865,173

(22) PCT Filed: Apr. 12, 2023
(86) PCT No.: PCT/NL2023/050192

§ 371 Date: Nov. 12, 2024

(30) Foreign Application Priority Data
May 18, 2022 (NL) 2031914

(51) Int. Cl. B29D 30/00

(52) U.S. Cl. CPC B29D 30/005

(57) ABSTRACT

A tire building machine for producing tire components and a method for providing human access to said tire building machine are provided. The tire building machine comprises a machine housing that defines a production area. The tire building machine further comprises an exchange station for exchanging production materials or tools with the tire building machine on a transport unit. The exchange station comprises a docking space for docking said transport unit, a floor, and an access portal in the machine housing for passing the transport unit over the floor into and out of the docking space. The docking space defines a walkway that is humanly accessible via the access portal and that, at the floor, is free of obstacles related to the docking of the transport unit when the transport unit is removed from the docking space.

### BACKGROUND

The invention relates to a tire building machine for producing tire components and a method for providing human access to said tire building machine.

A known tire building machine comprises a plurality of production stations for producing the tire components, an output station for outputting tire components on transport carts via an output corridor and a robot for transferring the tire components between the production stations and the output station. The range of the robot is limited. The robot is therefore located in a central position, closely surrounded by the production stations and the output station. To provide access to the robot, for example for maintenance, a human access corridor is provided between the stations extending up to the robot.

### SUMMARY OF THE INVENTION

A disadvantage of the known tire building machine is that the human access corridor consumes valuable floor space around the robot that could otherwise be occupied by a production station. However, gaining human access to the robot without the human access corridor is difficult and hazardous because of all kinds of parts and obstacles in the various stations, such as mechanical devices, cables, wires, pipes, guides and the like. In particular, the output station is provided with various guide tracks extending centrally over the floor of the output station for receiving and guiding the transport carts and locking clamps extending across the floor of the output station for engaging and retaining the said transport carts in said output station.

It is an object of the present invention to provide a tire building machine for producing tire components and a method for providing human access to said tire building machine, wherein human access while sacrificing less floor space for said human access.

According to a first aspect, the invention provides a tire building machine for producing tire components, wherein the tire building machine comprises a machine housing that defines a production area, wherein the tire building machine further comprises an exchange station within said production area for exchanging production materials or tools with the tire building machine on a transport unit, wherein the exchange station comprises a docking space for docking said transport unit, a floor that defines a footprint of said docking space for receiving the transport unit and an access portal in the machine housing for passing the transport unit over the floor into and out of the docking space, wherein the docking space defines a walkway that is humanly accessible via the access portal and that, at the floor, is free of obstacles related to the docking of the transport unit when the transport unit is removed from the docking space.

Hence, when the transport unit is removed, at least a part of the floor of the exchange station can be used as a walkway for safely gaining human access to the tire building device. By keeping said walkway free of obstacles that are used for docking the transport unit, it can be prevented that a human accessing the walkway trips over or is hit by any obstacles within said walkway. Moreover, as a separate, dedicated human access corridor is no longer required, the floor space that would normally be occupied by such a human access corridor can now be used to position one or more production stations of the tire building machine more strategically and/or more efficiently, for example in close proximity to a centrally located handling device, such as a robot.

In a preferred embodiment the walkway, at the floor, is free of any obstacles when the transport unit is removed from the docking space. In this manner, it can be prevented that a human accessing the walkway trips over or is hit by any obstacles within the walkway.

In another embodiment the tire building machine further comprises a handling station with a handling device, in particular a robot, for handling the tire components in the tire building machine, wherein the exchange station is located between the access portal and the handling station, wherein the walkway extends from the access portal up to the handling station. Preferably, the walkway extends up to the handling device in the handling station. Consequently, the handling device can be reached, for example for maintenance or other human interaction, by a human standing in the walkway.

In another embodiment the tire building machine comprises a plurality of production stations surrounding the handling station and blocking access to said handling station from any direction other than the exchange station. Hence, the only way to safely gain human access to the handling station is via the walkway in the exchange station.

In another embodiment the exchange station is configured for receiving the transport unit in a receiving direction into the docking space, wherein the walkway extends parallel or substantially parallel to said receiving direction. Hence, the human access can be gained in the same direction as the receiving direction. In particular, human access can be gained through the same access portal that is used to introduce the transport unit into the exchange station.

In another embodiment the exchange station comprises one or more guides for guiding the transport unit in a receiving direction into the docking space, wherein said one or more guides are located alongside the walkway. By providing the one or more guides alongside the walkway, it can be prevented that a human entering the walkway trips over or hits any of said one or more guides.

Similarly, the exchange station comprises one or more locking members for locking the transport unit against removal from the docking space, wherein the one or more locking members are located alongside the walkway. By providing the one or more locking members alongside the walkway, it can be prevented that a human entering the walkway trips over or hits any of said one or more guides.

In another embodiment the walkway has a width of at least five-hundred millimeters or at least eight-hundred millimeters. Such a width can provide a human with enough room to safely enter the tire building machine via the walkway.

In another embodiment the walkway extends from the access portal into the production area over a length of at least one-thousand millimeters. Hence, a human can enter the tire building machine via the walkway at least up to said length.

In another embodiment the walkway is free of obstacles related to the docking of the transport unit up to a height of at least one-thousand-and-eight-hundred millimeters above the floor when the transport unit is removed from the docking space. In this way, a human of average height can stand up straight within the walkway without hitting such obstacles.

Preferably, the walkway is free of any obstacles up to said height of at least one-thousand-and-eight-hundred millimeters above the floor when the transport unit is removed from the docking space. In this way, a human of average height can stand up straight within the walkway without hitting any obstacles.

In another embodiment the exchange station is configured for docking the transport unit in a docking area in which the transport unit blocks human access to the walkway via the access portal. Hence, when the transport unit is present in said docking area, the transport unit can effectively form part of the security measures that prevent that a human gains access to the tire building machine when said tire building machine is in operation.

In another embodiment the walkway meets the safety standards for human access to industrial machines. The walkway can thus be safely accessed according to the industry standards.

According to a second aspect, the invention provides a method for providing human access to a tire building machine according to any one of the embodiments of the first aspect of the invention, wherein the method comprises the steps of:
docking the transport unit in the docking space;
removing the transport unit from the docking space; and
gaining human access to the tire building machine via the walkway.

The method relates to the practical implementation of the tire building machine according to the first aspect of the invention and thus has the same technical advantages, which will not be repeated hereafter.

In a preferred embodiment the transport unit is received into the docking space in a receiving direction, wherein the human access is gained via the walkway extending parallel or substantially parallel to said receiving direction.

Additionally or alternatively, the transport unit is removed from the docking space via the access portal and the human access is gained via the access portal. Hence, the access portal can be used for both purposes. In particular, no separate, dedicated access portal is required for gaining human access to the tire building machine.

In another embodiment the tire building machine further comprises a handling station with a handling device for handling the tire components in the tire building machine, wherein the exchange station is located between the access portal and the handling station, wherein the walkway extends from the access portal up to the handling station, wherein the method further comprises the step of:
having human interaction with the handling device from the walkway. The human interaction may involve a maintenance operation, a setup or reconfiguration operation, or any other human interaction with the handling device.

In another embodiment the method further comprises the step of:
blocking human access to the walkway via the access portal with the use of the transport unit when said transport unit is docked in the docking space.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a top view of a tire building machine with an exchange station according to an exemplary embodiment of the invention, wherein a transport unit is docked in said exchange station;

FIG. 2 shows a top view of the tire building machine according to FIG. 1 with the transport unit removed from the exchange station; and

FIG. 3 shows a front view of the tire building machine according to FIG. 2.

### DETAILED DESCRIPTION OF THE INVENTION

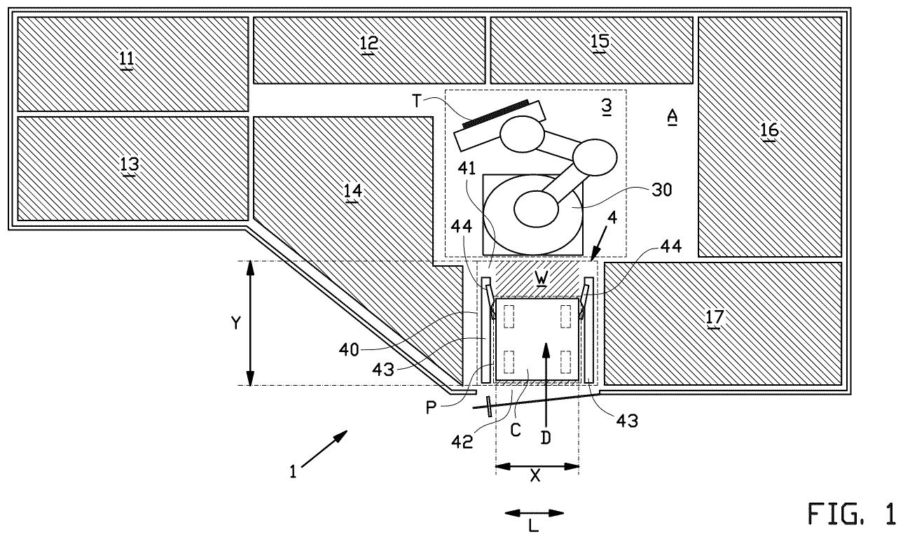

FIGS. 1, 2 and 3 shows a tire building machine 1 according to an exemplary embodiment of the invention for producing tire components T. In this example, the tire building machine 1 is a manufacturing line for producing and/or assembling beads and apexes into bead-apexes for use in a green or unvulcanized tire.

As shown in FIG. 1, the tire building machine 1 comprises a machine housing 2 that defines a production area A. The machine housing 2 may have physical walls and/or virtual screens to prevent unauthorized access to the production area A when the tire building machine 1 is active.

The tire building machine 1 comprises a plurality of production stations 11-17 within the production area A for producing, shaping and/or assembling the tire components T. The tire building machine 1 further comprises a handling station 3 with a handling device 30 for handling the tire components T in the tire building machine 1. The handling device 30 may for example be a robot or a robotic arm. The handling device 30 may pick-up, place and/or transfer the tire components T between the production stations 11-17. Because of the limited range of the handling device 30, the production stations 11-17 are positioned closely around or located as close as possible to the handling station 3.

As further shown in FIG. 1, the tire building machine 1 comprises an input station, an output station, or an exchange station 4 within said production area A for exchanging production materials or tools with the tire building machine 1. The exchange station 4 may be used for inputting carriers (so-called ‘spacers’), drum segments or other machine tools into the tire building machine 1. Alternatively, the exchange station 4 may be used for inputting production materials, such as beads, into the tire building machine 1 or for outputting the tire components T from the tire building machine 1. The exchange station 4 is also positioned close to or located as close as possible to the handling station 3 such that the handling station 3 can pick up the tire components T from any one of the production stations 11-17 and transfer said tire components T to the exchange station 4. In this example, the production stations 11-17 surround the handling station 3 and block access to said handling station 3 from any horizontal direction other than the exchange station 4.

The exchange station 4 is configured for receiving a storage unit or a transport unit C for transporting the tire components T out of the tire building machine 1. When the tire components T are bead-apexes, said tire components T are typically provided on spacers, known per se, which are stacked on top of each other on the transport unit C in a vertical direction.

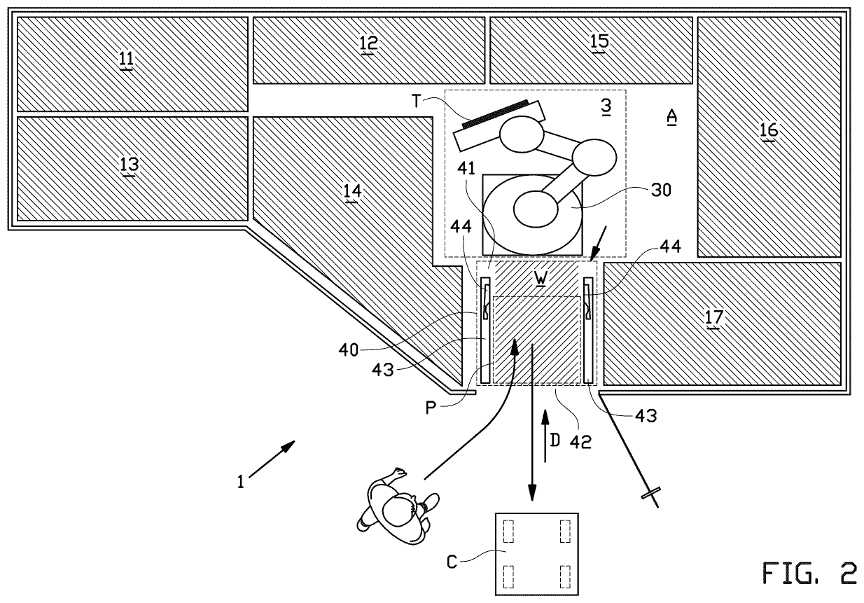

As best seen in FIG. 2, the exchange station 4 comprises a docking space 40 for receiving or docking the transport unit C. The exchange station 4 further comprises a floor 41, which may be the factory floor onto which the tire building machine 1 is placed or flooring placed on said factory floor. The floor 41 defines a surface area, a contour or a footprint of said docking space 40 for receiving the transport unit C. As schematically shown with the dashed square in FIG. 2, the exchange station 4 is configured for docking the transport unit C in a docking area P on said floor 41. The docking area P is preferably located close to or directly behind the access portal 42 in the receiving direction D, i.e. in a range of less than three-hundred millimeters from the access portal 42.

The exchange station 4 further comprises an access portal 42 in the machine housing 2 for passing the transport unit C over the floor 41 into and out of the docking space 40. In this example, the exchange station 4 is located between the access portal 42 and the handling station 3. The access portal 42 may be provided with a physical door or a virtual screen, such as a safety light curtain. The exchange station 4 is configured for receiving the transport unit C into the docking space 40 through the access portal 42 in a receiving direction D. In this example, the receiving direction D is perpendicular to the access portal 42.

The exchange station 4 further comprises guides 43 for guiding the transport unit C in the receiving direction D into the docking space 40. The exchange station 4 may optionally be provided with locking members 44 for locking the transport unit C against removal from the docking space 40 in a direction opposite to the receiving direction D. The locking members 44 may for example be shaped as clamps or hooks that are configured to engage with complementary shaped engagement members of the transport unit C. Both the guides 43 as well as the locking members 44 are configured for guiding and/or engaging the transport unit C from the sides of the exchange station 4, in particular from the lateral sides of said exchange station 4 considered in a lateral direction L transverse or perpendicular to the receiving direction D.

The transport unit C is a transport cart that is provided with wheels, preferably castor wheels, for rolling the transport unit C into and out of the exchange station 4 over the floor 41 of said exchange station 4 via the access portal 42. Preferably, the access portal 42 is provided without any threshold or sill such that the floor 41 of the exchange station 4 can be level or substantially level and/or continuous or substantially continuous with the factory floor outside of the tire building machine 1.

As shown schematically with the hatched surface area in FIG. 2, the floor 41 defines a walkway W that is accessible for a human or humanly accessible via the access portal 42. Note that the walkway W extends parallel or substantially parallel to the receiving direction D. The walkway W is characterized in that it is free of obstacles, such as mechanical devices, cables, wires, pipes, guides and the like, related to the docking of the transport unit C when the transport unit C is removed from the docking space 40. In particular, the guides 43 and/or the locking members 44 are located outside of, adjacent to or alongside the walkway W in the lateral direction L. In this exemplary embodiment, the walkway W is free of any obstacles when the transport unit C is removed from the docking space 40.

In this example, the walkway W extends from the access portal 42 up to the handling station 3, and in particular up to the handling device 30 in said handling station 3. Preferably, the walkway W extends from the access portal 42 into the production area A over a length Y of at least one-thousand millimeters.

Moreover, in this example, the walkway W has a width X, considered in the lateral direction L, of at least eight-hundred millimeters. When the transport unit C is docked in the docking area P, as shown in FIG. 1, the transport unit C can effectively block human access to the walkway W via the access portal 42. In particular, the transport unit C has a width in the lateral direction L that is equal to or greater than the width X of the walkway W.

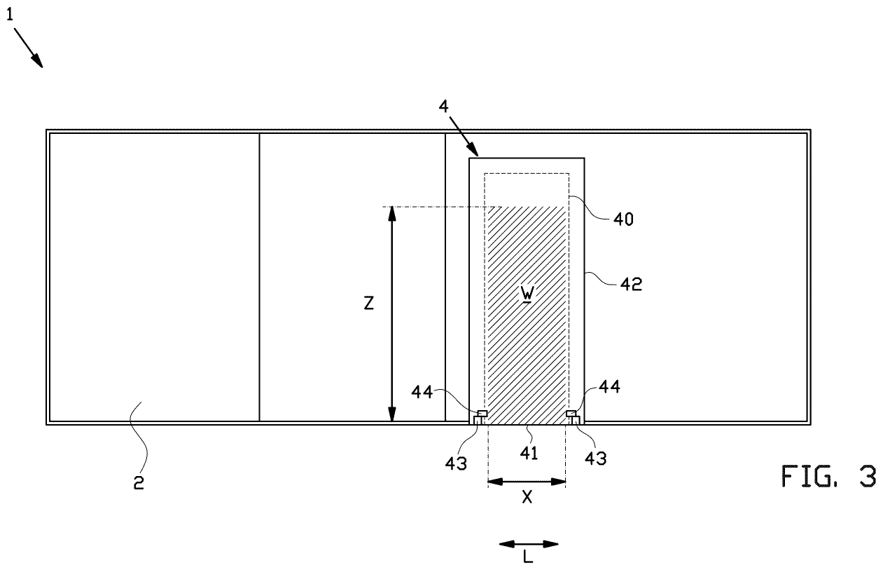

Finally, as shown in FIG. 3, the walkway W is free of obstacles related to the docking of the transport unit C, and more particularly free of any obstacles, up to a height Z of at least one-thousand-and-eight-hundred millimeters above the floor 41 when the transport unit C is removed from the docking space 40.

A method for providing human access to the aforementioned tire building machine 1 will now be briefly elucidated with reference to FIGS. 1 and 2.

FIG. 1 shows the situation in which the transport unit C is docked in the docking space 40. The transport unit C now effectively blocks human access to the tire building machine 1 via the access portal 42.

FIG. 2 shows the situation in which the transport unit C has been removed from the docking space 40 via the access portal 42. The tire building machine 1 has been at least partially switched off, in particular any of the production stations 11-17 close to the walkway W and/or the handling device 30. A human may now safely enter the tire building machine 1 via the access portal 42 and the walkway W. The human may carry out maintenance, repair, reconfiguration, setup operations or any other human interaction on the handling device 30 or any of the productions stations 11-17 from the walkway W.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

LIST OF REFERENCE NUMERALS

| | |
|---|---|
| 1 | tire building machine |
| 11-17 | production stations |
| 2 | machine housing |
| 3 | handling station |
| 30 | handling device |
| 4 | exchange station |
| 40 | docking space |
| 41 | floor |
| 42 | access portal |
| 43 | guide |
| 44 | locking member |
| C | transport unit |
| D | receiving direction |
| L | lateral direction |
| P | docking area |
| T | tire component |
| W | walkway |
| X | width |
| Y | length |
| Z | height |

1-21. (canceled)

22. A tire building machine for producing tire components, the tire building machine comprising a machine housing that defines a production area,
wherein the tire building machine further comprises an exchange station within said production area for exchanging production materials or tools with the tire building machine on a transport unit,
wherein the exchange station comprises a docking space for docking said transport unit, a floor that defines a footprint of said docking space for receiving the transport unit, and an access portal in the machine housing for passing the transport unit over the floor into and out of the docking space,
wherein the docking space defines a walkway that is humanly accessible via the access portal and that, at the floor, is free of obstacles related to the docking of the transport unit when the transport unit is removed from the docking space.

23. The tire building machine according to claim 22, wherein the walkway, at the floor, is free of any obstacles when the transport unit is removed from the docking space.

24. The tire building machine according to claim 22, wherein the tire building machine further comprises a handling station with a handling device for handling the tire components in the tire building machine,
wherein the exchange station is located between the access portal and the handling station,
wherein the walkway extends from the access portal up to the handling station.

25. The tire building machine according to claim 24, wherein the walkway extends up to the handling device in the handling station.

26. The tire building machine according to claim 24, wherein the handling device is a robot.

27. The tire building machine according to claim 24, wherein the tire building machine comprises a plurality of production stations surrounding the handling station and blocking access to said handling station from any direction other than the exchange station.

28. The tire building machine according to claim 22, wherein the exchange station is configured for receiving the transport unit in a receiving direction into the docking space,
wherein the walkway extends parallel to said receiving direction.

29. The tire building machine according to claim 22, wherein the exchange station comprises one or more guides for guiding the transport unit in a receiving direction into the docking space,
wherein said one or more guides are located alongside the walkway.

30. The tire building machine according to claim 22, wherein the exchange station comprises one or more locking members for locking the transport unit against removal from the docking space,
wherein the one or more locking members are located alongside the walkway.

31. The tire building machine according to claim 22, wherein the walkway has a width of at least five-hundred millimeters.

32. The tire building machine according to claim 22, wherein the walkway has a width of at least eight-hundred millimeters.

33. The tire building machine according to claim 22, wherein the walkway extends from the access portal into the production area over a length of at least one-thousand millimeters.

34. The tire building machine according to claim 22, wherein the walkway is free of obstacles related to the docking of the transport unit up to a height of at least one-thousand-and-eight-hundred millimeters above the floor when the transport unit is removed from the docking space.

35. The tire building machine according to claim 34, wherein the walkway is free of any obstacles up to said height of at least one-thousand-and-eight-hundred millimeters above the floor when the transport unit is removed from the docking space.

36. The tire building machine according to claim 22, wherein the exchange station is configured for docking the transport unit in a docking area in which the transport unit blocks human access to the walkway via the access portal.

37. The tire building machine according to claim 22, wherein the walkway meets the safety standards for human access to industrial machines.

38. A method for providing human access to a tire building machine according to claim 22, wherein the method comprises the steps of:
docking the transport unit in the docking space;
removing the transport unit from the docking space; and
gaining human access to the tire building machine via the walkway.

39. The method according to claim 38, wherein the transport unit is received into the docking space in a receiving direction,
wherein the human access is gained via the walkway extending parallel to said receiving direction.

40. The method according to claim 38, wherein the transport unit is removed from the docking space via the access portal and
wherein the human access is gained via the access portal.

41. The method according to claim 38, wherein the tire building machine further comprises a handling station with a handling device for handling the tire components in the tire building machine,
wherein the exchange station is located between the access portal and the handling station,
wherein the walkway extends from the access portal up to the handling station, wherein the method further comprises the step of:
having human interaction with the handling device from the walkway.

42. The method according to claim 38, wherein the method further comprises the step of:
blocking human access to the walkway via the access portal with the use of the transport unit when said transport unit is docked in the docking space.
